(19) United States
(12) Patent Application Publication
(10) Pub. No.: US 2005/0279437 A1
(43) Pub. Date: Dec. 22, 2005

(54) Tire structure

(76) Inventor: Tony Hsieh, Chang Hua (TW)

Correspondence Address: CHARLES E. BAXLEY, ESQ., 90 JOHN STREET, THIRD FLOOR, NEW YORK, NY, 10038, US

(21) Appl. No.: 10/870,419

(22) Filed: Jun. 16, 2004

(51) Int. Cl. B60C 17/00; B60C 19/12

(52) U.S. Cl. 152/165; 152/157

(57) ABSTRACT

The present invention relates to an improved tire structure, the method of producing the tire in accordance with the present invention is explained as follows: initially the inner tire is semi-vulcanized (roughly shaped) and then installed in the outer tire as an inner mold of the tire, after that, the inner tire is vulcanized synchronously with the outer tire (heating, pressurizing and blowing). Through the above-mentioned processes, the outer surface of the inner tire is tightly combined with the inner surface of the outer tire. The inner tire and the outer tire can be possessed with strong combining power and strength since they are made from the same material, so as to produce a new style air free tire.

### BACKGROUND OF THE INVENTION

1. Field of the Invention

The present invention relates to a tire structure, and more particularly to an air free tire structure.

2. Description of the Prior Arts

Conventional tires are generally divided into three categories: solid tire, tire having inner tire, tire without inner tire.

The solid tire is usually used on heavy-loading transportation facilities and it is a little heavy due to solid construction, however the solid tire is relatively durable.

As concerns the tire having inner tire, the air will suddenly escape when the inner tire and the outer tire are punctured synchronously by sharp objects, and it is inconvenient for the user to repair the inner tire since it only can be repaired when it is disassembled from the outer tire.

The tire without inner tire is relatively light since it has no inner tire, and the innermost ply of this tire is made of airtight material, thereby, it is safe that air will not be escaped suddenly when the tire is punctured by sharp objects, furthermore, the tire can be repaired directly at the broken position.

However, all the above-mentioned tires need to be processed in a vulcanization process, which is to shape and vulcanize the tire by putting it into a mold (heating, pressurizing and blowing). During this process, an inner mold needs to be used to support the inner wall of the tire, and it the inner mold only can be removed after the vulcanization process. This process is very time-consuming, furthermore, before using the inner mold, the user also has to apply release agent to the contact surface between the tire and the inner mold, in order to separate the inner mold from the tire smoothly.

The present invention has arisen to mitigate and/or obviate the afore-described disadvantages of the conventional tire structure.

### SUMMARY OF THE INVENTION

The primary object of the present invention is to provide an improved tire structure, the method of producing the tire in accordance with the present invention is explained as follows: initially the inner tire is semi-vulcanized (roughly shaped) and then installed in the outer tire as an inner mold of the tire, after that, the inner tire is vulcanized synchronously with the outer tire (heating, pressurizing and blowing). Through the above-mentioned processes, the outer surface of the inner tire is tightly combined with the inner surface of the outer tire. The inner tire and the outer tire can be possessed with strong combining power and strength since they are made from the same material, so as to produce a new style air free tire.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a perspective view of a tire in accordance with the present invention;

FIG. 2 is a partial cross sectional view of a tire in accordance with a first embodiment of the present invention;

FIG. 3 is a partial cross sectional view of a tire in accordance with a second embodiment of the present invention.

### DETAILED DESCRIPTION OF THE PREFERRED EMBODIMENTS

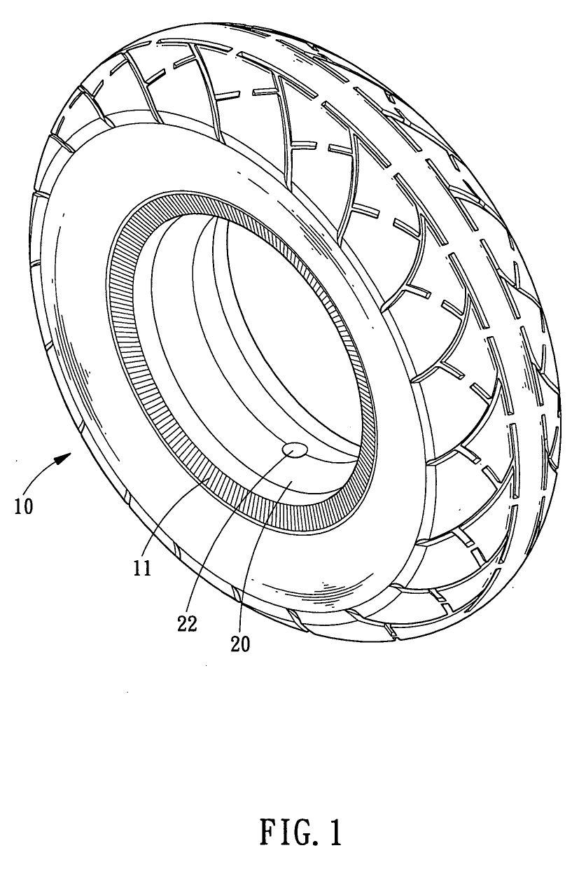

Referring to FIG. 1, wherein a tire in accordance with the present invention is shown and comprises an outer tire 10 and an inner tire 20.

The outer tire 10 is made from elastomeric polymer and provided with a lip portion 11 at an end of both sidewalls thereof. Five steel coils 12 are annularly provided in the lip portion 11. Both the outer tire 10 and the lip portion 11 are interiorly provided with a cord-fabric layer 13 that is used to wrap the respective steel coils 12.

The inner tire 20 is made from the same elastomeric polymer as the outer tire 10, which is a hollow ring member having a chamber 21. A through hole 22 is defined at a predetermined position of the inner tire 20 and which is connected to the chamber 21. The inner tire 20 is combined in the outer tire 10 in a manner that the outer surface of the inner tire 20 is integrally combined with the inner surface of the outer tire 10.

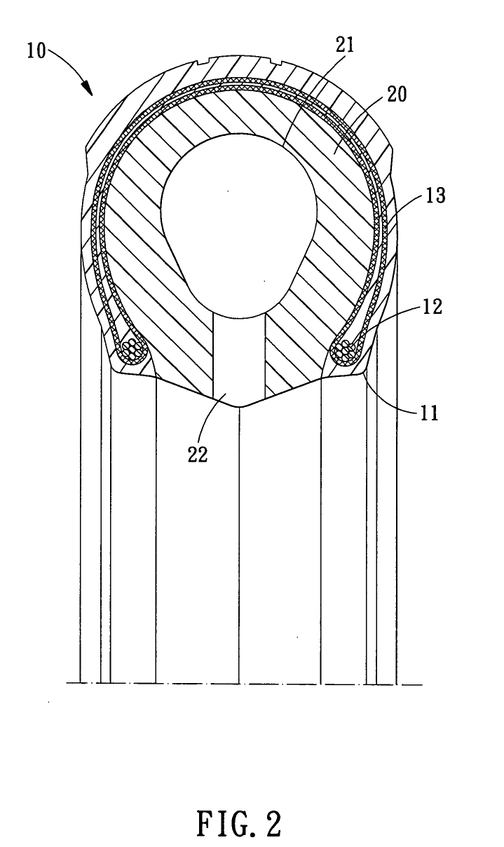

With reference to FIGS. 1 and 2, the method of combining the inner tire with the outer tire in accordance with the present invention is explained as follows: Initially the inner tire 20 is semi-vulcanized (roughly shaped) and then installed in the outer tire 10 as an inner mold of the tire, after that, the inner tire 20 is vulcanized synchronously with the outer tire 10 (heating, pressurizing and blowing). Through the above-mentioned processes, the outer surface of the inner tire 20 is tightly combined with the inner surface of the outer tire 10. The inner tire 20 and the outer tire 10 can be possessed with strong combining power and strength since they are made from the same material, so as to form an air free tire.

In addition, due to the inner tire 20 is formed in the shape of a hollow ring, such that the weight of the combination of the outer tire 10 and the inner tire 20 will be relatively lighter than that of the solid tire.

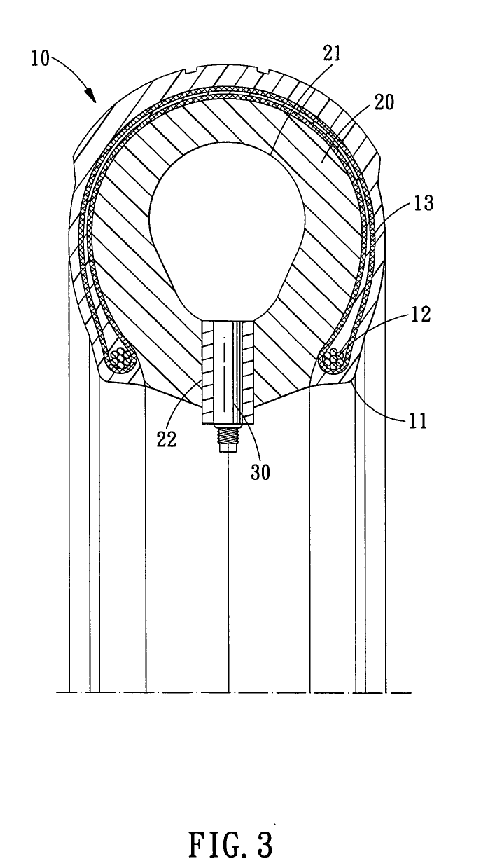

Referring to FIG. 3, wherein a tire in accordance with a second preferred embodiment of the present invention is shown. To increase the load bearing pressure of the outer tire 10, an air tap 30 is provided in the through hole 22 of the inner tire 20 for enabling the user to inflate air into the chamber 21 of the inner tire 20.

It is to be noted that the above-mentioned outer tire 10 can be in form of radial ply tire or diagonal ply tire.

While we have shown and described various embodiments in accordance with the present invention, it should be clear to those skilled in the art that further embodiments may be made without departing from the scope of the present invention.

1. A tire structure comprising:
an outer tire interiorly combined with an inner tire, wherein the outer tire and the inner tire are made from same material, the inner tire formed in the shape of a hollow ring and integrally combined with the outer tire.

2. The tire structure as claimed in claim 1, wherein the inner tire is provided with a through hole, a gas tap is received in the through hole, which is used to inflate air into a chamber of the inner tire, so as to increase load bearing pressure of the outer tire.
